(19) United States
(12) Patent Application Publication
(10) Pub. No.: US 2026/0095098 A1
(43) Pub. Date: Apr. 2, 2026

(54) EXTENSION OF CASCODE SWITCHING CONVERTER CIRCUIT BEYOND THE PROCESS BREAKDOWN VOLTAGE

(71) Applicant: TEXAS INSTRUMENTS INCORPORATED, Dallas, TX (US)

(72) Inventors: Kevin Scoones, San Jose, CA (US); Tianyu Chang, Richardson, TX (US); Qian Zhi, Richardson, TX (US); Bumkil Lee, Allen, TX (US); Chandradevi Ulaganathan, McKinney, TX (US); Chienyu Huang, Plano, TX (US)

(21) Appl. No.: 18/899,723

(22) Filed: Sep. 27, 2024

(51) Int. Cl. H02M 3/158; H02M 1/32

(52) U.S. Cl. CPC H02M 3/158; H02M 1/32

(57) ABSTRACT

An apparatus includes a first sensing circuit, a first clamping circuit, a first high-side power switch, a second sensing circuit, a second clamping circuit, and a second high-side power switch. The first sensing circuit detects a voltage change across the first high-side power switch exceeding a first threshold in response to a converter circuit switching. The first sensing circuit triggers the first clamping circuit to clamp a voltage across the first high-side power switch in response to detecting that the voltage change across the first high-side power switch exceeds the first threshold. The second sensing circuit detects a voltage change across the second high-side power switch exceeding a second threshold. The second sensing circuit triggers the second clamping circuit to clamp a voltage across the second high-side power switch in response to detecting that the voltage change across the second high-side power switch exceeds the second threshold.

### BACKGROUND

High-power applications have increased in recent years. For example, the increase in the number of electric vehicles (EV), solar farms, homes with solar panels, etc., have resulted in an increased number of high-power applications. In general, high-power application involve battery charging/discharging and/or battery monitoring. In some applications, batteries (as an example) may be stacked together to generate a high voltage, e.g., 150V or more.

Circuitries, e.g., monitoring circuitry, associated with the high voltage application may generate their internal low voltage rails from the source, e.g., battery pack. For example, linear regulators may be used but they result in power loss and are therefore inefficient. As such, some have used switching converter circuits to improve efficiency in comparison to linear regulators. The improvement in efficiency is highly beneficial in high voltage applications, including EV that may extend the driving range.

The high side switches and the low side switches for the converter circuit should withstand the high voltage. In general, maximum battery pack voltage can be as high as 800-900 V, as an example, and a stack of battery monitors may be used to monitor the batteries that should withstand these high voltage values, e.g., if 6 battery monitoring devices are used then each battery monitoring device should withstand 900/6 which is 150 V as an example. Withstanding a higher voltage by a battery monitoring device may reduce cost by reducing the number of battery monitoring devices. However, releasing a new generation of high voltage process may take years while the high voltage industry such as EV monitoring market move at a much faster pace by releasing products in a shorter amount of time in comparison to the high voltage process.

Accordingly, some conventional systems have expanded the converter circuits to operate beyond their process breakdown voltage to address the gap in time between product release and the availability of high voltage process. Stacked switches and multilevel converter circuits have been used to increase the operating voltage of converter circuits beyond the device breakdown voltage. However, the conventional devices to expand the converter circuits to operate beyond their process breakdown voltage suffer from limitations such as supporting low voltage (e.g., less than 7.7 V, less than 15 V, etc.) that are not suitable for high-power applications, inefficiency (e.g., incompatible with bootstrapped converter circuits, use of p-channel metal-oxide-semiconductor field-effect transistors (PMOS), use of diode on the low side, etc.), high quiescent current that is not favorable for EV application, etc.), limited conversion ratio (e.g., step down voltage of 2 or 3 to 1) to prevent high side and low side from oxide breakdown, high bill of material cost (e.g., using multiple auxiliary rails, more silicon area, additional circuitry that increases complexity, etc.), high pin count (e.g., using multiple auxiliary rails), stability for outputting a clean signal, robustness (e.g., inability to react fast during switching due to use of diodes) and low yield resulting from components of the converter circuits experiencing breakdown when fabricated components are not ideal.

### SUMMARY

In an example, an apparatus includes a first sensing circuit, a first clamping circuit, a first high-side power switch, a second sensing circuit, a second clamping circuit, and a second high-side power switch. The first sensing circuit is configured to detect a voltage change across the first high-side power switch exceeding a first threshold in response to a converter circuit switching. The first sensing circuit is further configured to trigger the first clamping circuit to clamp a voltage across the first high-side power switch in response to detecting that the voltage change across the first high-side power switch exceeds the first threshold. The second sensing circuit is configured to detect a voltage change across the second high-side power switch exceeding a second threshold. The second sensing circuit is further configured to trigger the second clamping circuit to clamp a voltage across the second high-side power switch in response to detecting that the voltage change across the second high-side power switch exceeds the second threshold.

In at least one example, a system includes a high side circuit, a plurality of high-side power switches coupled to the high side circuit, a low side circuit, a plurality of low-side power switches coupled to the low side circuit, and a converter circuit coupled to the plurality of high-side power switches and further coupled to the plurality of low-side power switches. The high side circuit is configured to detect whether a voltage change across a high-side power switch of the plurality of high-side power switches exceeds a threshold. The high side circuit is configured to clamp a voltage across the high-side power switch in response to detecting that the voltage change across the high-side power switch exceeds the threshold. The low side circuit is configured to conduct in response to the converter circuit switching from a low voltage value to a high voltage value. The low side circuit is configured to engage a low-side power switch of the plurality of low-side power switches in response to the converter circuit switching from the low voltage value to the high voltage value and wherein the engaging the low-side power switch distributes a voltage approximately uniformly across low-side power switches of the plurality of low-side power switches.

### BRIEF DESCRIPTION OF THE DRAWINGS

FIG. 1 is a schematic diagram of a system with a circuitry to extend cascode switches of a converter circuit to operate beyond the process breakdown voltage, in an example.

FIG. 2 is another schematic diagram of a system with a circuitry to extend cascode switches of a converter circuit to operate beyond the process breakdown voltage, in an example.

FIG. 3 is yet another schematic diagram of a system with a circuitry to extend cascode switches of a converter circuit to operate beyond the process breakdown voltage, in an example.

FIG. 4 is a performance of the system with a circuitry to extend cascode switches of a converter circuit to operate beyond the process breakdown voltage, in an example.

FIG. 5 is a schematic diagram of an EV including a system with a circuitry to extend cascode switches of a converter circuit to operate beyond the process breakdown voltage, in an example.

### DETAILED DESCRIPTION

The same reference numbers or other reference designators are used in the drawings to designate the same or similar (either by function and/or structure) features.

The examples of the system with circuitry, as described below, extend cascode switches of a converter circuit to operate beyond the process breakdown voltage. The examples, expand the ability to operate beyond the process breakdown voltage as well as enabling the converter circuit to support high voltage (e.g., 150V) efficiently (compatible with bootstrap converter circuit and without using PMOS) with high conversion ratio (e.g., approximately 150V to 6V) with increased stability, at a lower pin count, and lower quiescence current.

The examples are described with respect to EVs and monitoring circuit associated with a battery pack for illustrative purposes and should not be construed as limiting the scope. For example, the converter circuits and other circuitries are equally applicable to other high-power applications, e.g., solar panel.

In an EV system, the battery monitoring circuitry is paired with one or more battery cells that may be stacked. The battery monitoring circuitry may provide various information associated with the battery or battery pack such as cell voltage, cell current, temperature for the state of charge (SOC) or state of health (SOH), detection of battery faults, etc. The monitoring circuitry generally uses the source, e.g., battery pack, to generate its internal low voltage rails. However, the battery pack may include batteries that are stacked and may reach high voltages such as 800-900V. As such, the monitoring circuit (a stack of monitoring circuit may be used such as 6 that should withstand 900/6 that is 150V) may use a converter circuit to step down the voltage to generate its internal low voltage rails. According to some examples, a circuity is used to protect the high side and the low side switches of a converter circuit, e.g., buck converter, used in monitoring circuit from breakdown voltage while enabling the converter circuit to deliver a fixed voltage when the switches of the converter circuit switch between high and low voltage.

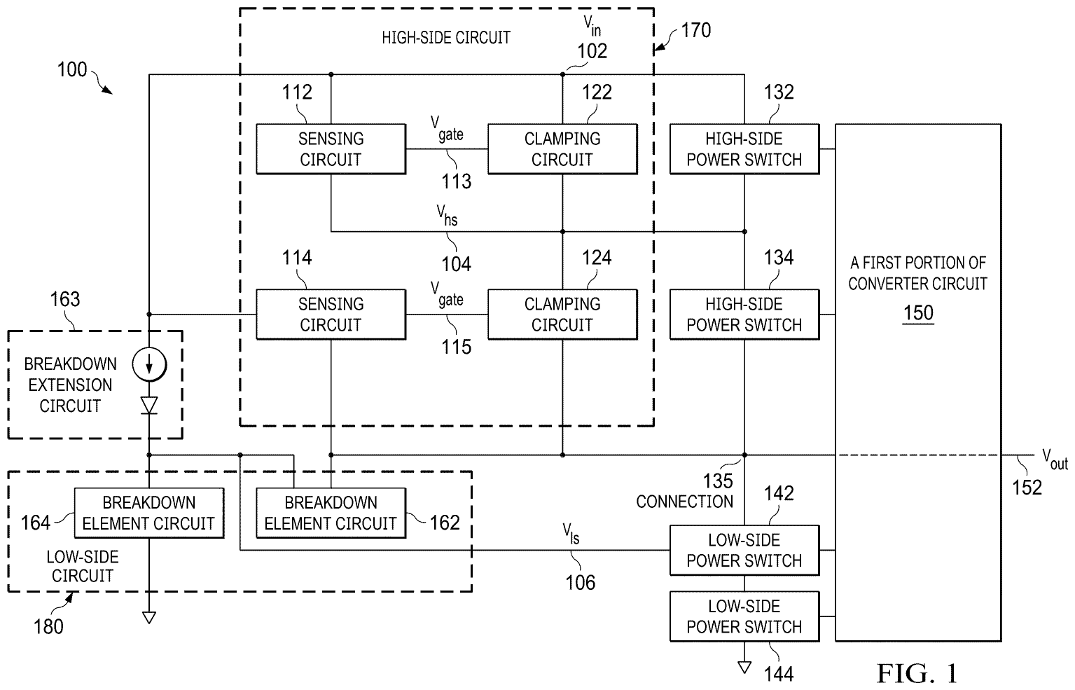

FIG. 1 is a schematic diagram of a system 100 with a circuitry with cascode switches of a converter circuit to operate beyond the process breakdown voltage (e.g., gate-drain or drain-source breakdown voltage) of a single switch, in an example. The system 100 of FIG. 1 is compatible with both high-side and low-side stacked switches (e.g., FETs) of bootstrapped converter circuitries as well as asynchronous converter circuitries, thereby enabling more efficient designs, which is fully integrated without requiring additional auxiliary rails, thereby reducing cost, pin count, silicon area, and build of material to name a few. Additionally, the system 100 of FIG. 1 utilizes existing node process at a lower voltage rating to enable the system 100 of FIG. 1 to operate for higher power applications despite the lower voltage rating. Moreover, the system 100 of FIG. 1 senses and clamps the voltage associated with the switches during fast switching transients, thereby making the system robust across fabrication variations and preventing device breakdown and damage across a wide range of operating conditions. The system 100 generates dynamic gate voltages for stacked power switches, e.g., FETs, to generate DC gate voltages unlike the conventional systems, thereby no longer limited by oxide breakdown and as such capable of supporting voltages beyond the breakdown operation. Additionally, the system 100 of FIG. 1 achieves a high conversion ratio (e.g., 150V to 6 V) as opposed to a 2:1 conversion ratio, of the conventional system, by decoupling the voltages on the high side and low side (described in greater detail below).

The system 100 includes a first portion of converter circuit 150 that uses the power, e.g., Vᵢₙ 102, from a high voltage source, e.g., battery pack that may be approximately 150V, to generate its internal low voltage rails. It is appreciated that throughout the application, a high voltage of 150V is used by using 6 battery monitoring devices for a stacked battery with voltages as high as 900V as an example for illustration purposes and should not be construed as limiting the scope. In other words, the first portion of converter circuit 150 may step down the voltage from approximately 150V to approximately 5-8V. According to some examples, the first portion of converter circuit 150 may have an associated set of switches to drive the output voltage Vₒᵤₜ 152 when the internal connection 135 is switching between high and low voltages. In one nonlimiting example, the set of switches may include high-side power switches 132 and 134 (turning on/off) that are part of the converter circuit and are for driving the high voltage side of the first portion of converter circuit 150 (to operate in buck converter or step down converter as an example) and low-side power switches 142 and 144 for driving the low voltage side of the first portion of converter circuit 150.

The system 100 includes a high side circuit 170 configured to protect high-side power switches 132 and 134 and other circuitry components associated with the high side of the first portion of converter circuit 150 when the voltage on connection 135 is asserted low to 0V, and when the first portion of converter circuit 150 outputs a fixed voltage Vₒᵤₜ 152. According to some examples, protecting the high-side power switches 132 and 134 as well as other circuitry components within the first portion of converter circuit 150 is by sensing high voltage associated with the high side of the first portion of converter circuit 150 and to distribute the stress, e.g., voltage, between the high-side power switches 132 and 134 to protect the power switches 132 and 134 and the circuitry components within the first portion of converter circuit 150 from experiencing breakdown voltage.

The system 100 includes a low side circuit 180 configured to protect low-side power switches 142 and 144 and other circuitry components associated with low side of the first portion of converter circuit 150 when the voltage on connection 135 asserted high to 150V and when the first portion of converter circuit 150 outputs the fixed voltage Vₒᵤₜ 152. According to some examples, protecting the low-side power switches 142 and 144 as well as other circuitry components within the first portion of converter circuit 150 is by sensing high voltage associated with the low side of the first portion of converter circuit 150 and to distribute the stress, e.g., voltage, between the low-side power switches 142 and 144 to protect the power switches 142 and 144 and the circuitry components within the first portion of converter circuit 150 from experiencing breakdown voltage.

In one example, the high side circuit 170 includes a sensing circuit 112 coupled to a clamping circuit 122 associated with the high-side power switch 132. The high side circuit 170 also includes a sensing circuit 114 coupled to a clamping circuit 124 that is associated with high-side power switch 134.

According to an example, the input voltage Vᵢₙ 102 may be a high voltage, e.g., approximately 150V. The sensing circuit 112 is configured to detect the voltage difference across the high-side power switch 132. In other words, the sensing circuit 112 detects the voltage difference between Vᵢₙ 102 and Vₕₛ 104. If the sensing circuit 112 determines that the voltage difference across the high-side power switch 132 is greater than a predetermined threshold, e.g., 75V, it causes a triggering signal, e.g., V_{gate} 113, to be asserted. Asserting the triggering signal causes the clamping circuit 122 to clamp the voltage to a fixed range, e.g., clamp the voltage exceeding a particular threshold such as 75V thus fixing the voltage from 0-75V. For example, if the voltage difference across the high-side power switch 132 is detected to be 85V and if the threshold is 75V, then the sensing circuit 112 triggers the clamping circuit 122 to clamp the difference between the voltage difference across the high-side power switch 132 and the threshold, thereby clamping 10V from the voltage difference of 85 V to reduce the voltage across the high-side power switch 132 from 85V to 75V.

Similarly, the sensing circuit 114 is configured to detect the voltage difference across the high-side power switch 134. In other words, the sensing circuit 114 detects the voltage difference between connection 135 and Vₕₛ 104. If the sensing circuit 114 determines that the voltage difference across the high-side power switch 134 is greater than a predetermined threshold, e.g., 75V, it causes a triggering signal, e.g., V_{gate} 115, to be asserted. Asserting the triggering signal causes the clamping circuit 124 to clamp the voltage to a fixed range, e.g., clamp the voltage exceeding a particular threshold such as 75V thus fixing the voltage from 0-75V. For example, if the voltage difference across the high-side power switch 134 is detected to be 85V and if the threshold is 75V, then the sensing circuit 114 triggers the clamping circuit 124 to clamp the difference between the voltage difference across the high-side power switch 134 and the threshold, thereby clamping 10V from the voltage difference of 85V to reduce the voltage across the high-side power switch 134 from 85V to 75V. It is appreciated that the threshold for high-side power switch 132 and 134 may or may not be the same and discussions with respect to the threshold being the same is for illustrative purposes and should not be construed as limiting the scope. For example, while the threshold for high-side power switch 132 may be 75V the threshold for the high-side power switch 134 may be 65V.

Accordingly, the first portion of converter circuit 150 may be operated beyond its breakdown voltage by distributing the voltage stress across the high-side power switches 132-134 by leveraging the sensing circuits 112 and 114 that detect voltage above the breakdown voltage. The sensing circuits 112-114 in response detecting a high voltage stress, trigger the clamping circuits 122-124 to clamp the voltage above a given threshold and cause the voltage stress to be distributed, e.g., high-side power switches 132-134, to reduce the voltage stress on a given component.

In one example, the low side circuit 180 includes a breakdown element circuit 162 and 164. The low side circuit 180 is coupled to the low-side power switch 142. When the first portion of converter circuit 150 is in an off state (e.g., not switching), the breakdown extension circuit 163 ensures that a steady state condition is achieved by for example using the breakdown element circuit 162 to ensure that the stacked switches, e.g., high-side power switches 132-134 and low-side power switches 142-144 share the voltage stress, e.g., equally distributed, such that the maximum operating voltage can be achieved. In contrast, when the first portion of converter circuit 150 is in an on state (e.g., switching), and the connection 135 being asserted high, e.g., approximately 150V, the breakdown element circuit 164 conducts, e.g., asserting Vₗₛ 106 high. Asserting the Vₗₛ 106 high causes the low-side power switch 142 to engage and share the voltage that would otherwise have to be borne by the low-side power switch 144 alone. In other words, the low-side power switch 142, when engaged, shares the voltage stress, e.g., equally, as the low-side power switch 144.

It is appreciated that two high-side power switches and two low-side power switches are described for illustration purposes and should not be construed as limiting the scope. For example, any number of switches (e.g., three or more) may be used for the high side and more than two switches for the low side may be used. As illustrated, in an on state (first portion of converter circuit 150 switching), the power for the high-side power switches 132-134 and low-side power switches 142-144 are independent of the input voltage, Vᵢₙ 102. Accordingly, the configuration of FIG. 1 operates in high voltages of approximately 150V and not limited to oxide breakdown. Additionally, efficient power stage design is implemented by protecting the high side as well as the low side (e.g., low-side power switches). Moreover, the configuration of FIG. 1 achieves a high conversion ratio (e.g., 150V to 6 V) as opposed to a 2:1 conversion ratio by decoupling the voltages on the high side and low side from the Vₒᵤₜ 152 of the first portion of converter circuit 150. Furthermore, the robustness of the architecture is improved by utilizing sensing and clamping circuitries (fast switching transients of stacked high-power and low-side power switches) and as a result prevents device breakdown and damage to the circuitry across a wide range of operating conditions. Additionally, the cost is reduced because additional auxiliary rails are eliminated, thereby reducing the pin outs, silicon area, and build of materials. According to some examples, the efficiency is improved since the described architecture is compatible with bootstrapped converter circuities as well as synchronous converter circuitries. Lower quiescence current is associated with the configuration of FIG. 1 because no additional circuitry is needed to stabilize the regulated auxiliary rails.

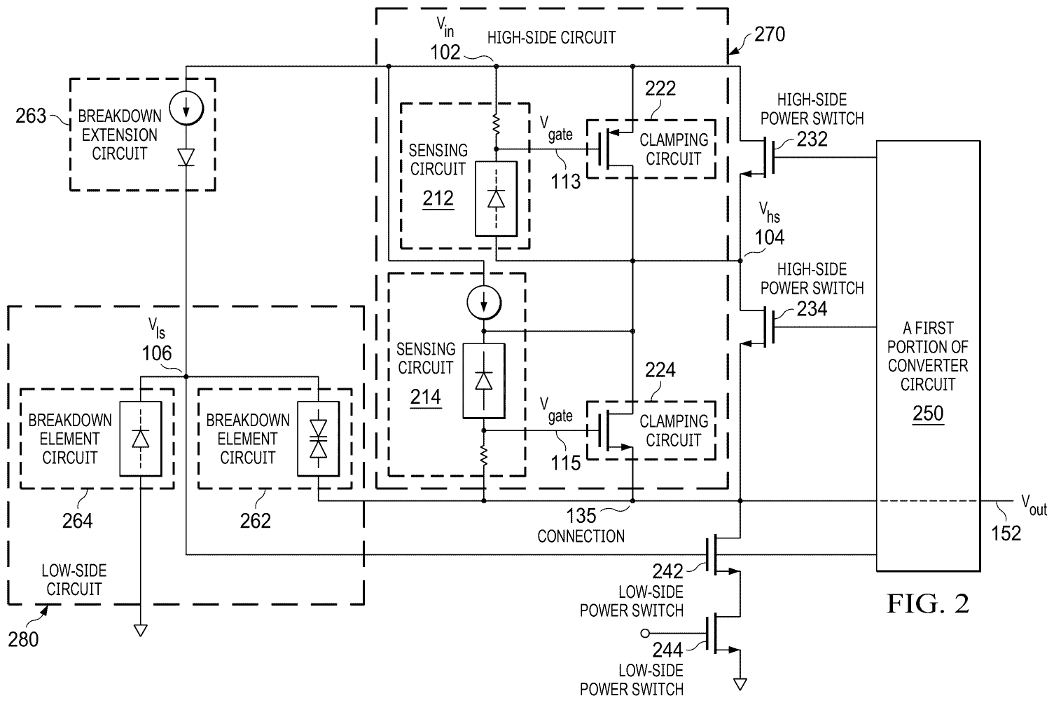

FIG. 2 is another schematic diagram of a system 200 with a circuitry to extend cascode switches of a converter circuit to operate beyond the process breakdown voltage, in an example. System 200 includes a first portion of converter circuit 250, high-side power switches 232-234, low-side power switches 242-244, high side circuit 270, low side circuit 280, and a breakdown extension circuit 263. The first portion of converter circuit 250 is similar to the first portion of converter circuit 150, as described above. The high-side power switches 232-234 are similar to the high-side power switches 132-134 and low-side power switches 242-244 are similar to low-side power switches 142-144, as described above. The high side circuit 270 is similar to the high side circuit 170 and the low side circuit 280 is similar to the low side circuit 180, as described above. The breakdown extension circuit 263 is similar to the breakdown extension circuit 163, as described above. The high side circuit 270 may include sensing circuits 212-214 and the clamping circuits 222-224 that are similar to the sensing circuits 112-114 and the clamping circuits 122-124, as described above. Moreover, the low side circuit 280 includes breakdown element circuits 262-264 that are similar to that of breakdown element circuits 162-164, as described above.

In the example of FIG. 2, one implementation of the sensing circuit 212 is shown. The sensing circuit 212 may include a diode (or stack of diodes) and a resistor. The diode in response to the voltage difference across the high-side power switch 232 (e.g., voltage difference between Vᵢₙ 102 and Vₕₛ 104) exceeding a threshold (breakdown threshold of the diode) conducts current across the resistor which puts a voltage along the gate, e.g., V_{gate} 113, of the FET switch of the clamping circuit 222. In other words, the sensing circuit 212 actively senses the voltage across the high-side power switch 232 and in response to determining that the voltage difference exceeds a given threshold it triggers the clamping circuit 222 to clamp the voltage. In other words, the sensing circuit 212 asserts voltage for V_{gate} 113 to trigger the clamping circuit 222 to start clamping by turning on the switch (FET), thereby clamping the voltage. For example, if the voltage across the high-side power switch 232 is detected to be 90V and the threshold voltage is 75V then the diode of the sensing circuit 212 conducts turning on the switch of the clamping circuit 222 that clamps 15V from the total 90V, thereby bringing down the voltage across the high-side power switch 232 to 75V and limiting the voltage to a range between 0-75V. In other words, the clamping circuit 222 provides a discharge path to bring down the voltage across the high-side power switch 232, thereby reducing the stress (or voltage) being experienced by the high-side power switch 232 and components within the first portion of converter circuit 250 that the high-side power switch 232 is connected to.

In the example of FIG. 2, one implementation of the sensing circuit 214 is shown. The sensing circuit 214 may include a diode (or stack of diodes), a resistor, and a current source. The diode in response to the voltage difference across the high-side power switch 234 (e.g., voltage difference between V_{connection} 135 and Vₕₛ 104) exceeding a threshold (breakdown threshold of the diode in the sensing circuit 214) conducts current across the resistor which puts a voltage along the gate, e.g., V_{gate} 115, of the FET switch of the clamping circuit 224. In other words, the sensing circuit 214 actively senses the voltage across the high-side power switch 234 and in response to determining that the voltage difference exceeds a given threshold it triggers the clamping circuit 224 to clamp the voltage. In other words, the sensing circuit 214 asserts voltage for V_{gate} 115 to trigger the clamping circuit 224 to start clamping by turning on the switch (FET), thereby clamping the voltage. For example, if the voltage across the high-side power switch 234 is detected to be 90V and the threshold voltage is 75V then the diode of the sensing circuit 214 conducts turning on the switch of the clamping circuit 224 that clamps 15V from the total 90V, thereby bringing down the voltage across the high-side power switch 234 to 75V and limiting the voltage to a range between 0-75V. In other words, the clamping circuit 224 provides a discharge path to bring down the voltage across the high-side power switch 234, thereby reducing the stress (or voltage) being experienced by the high-side power switch 234 and components within the first portion of converter circuit 250 that the high-side power switch 234 is connected to. The current source of the sensing circuit 214 establishes a steady state condition when the first portion of converter circuit 250 is not switching (from low to high or high to low) and is in an off state, e.g., connection 135 sees a steady voltage, by distributing the voltage across each of the high-side power switches 232 and 234 equally (e.g., voltage across Vᵢₙ 102 and Vₕₛ 104 is distributed to be approximately the same as voltage between V_{connection} 135 and Vₕₛ 104), thereby distributing the burden across high-side power switches 232 and 234 as well as across components within the first portion of converter circuit 250 to which high-side power switches 232 and 234 are connected.

The breakdown element circuit 262 may include one or more stacked Zener diodes that when the first portion of converter circuit 250 is in an off state overrides the static bias condition established by the breakdown element circuit 264 and breakdown extension circuit 263, thereby enabling Vₗₛ 106 to follow the voltage at connection 135 when it falls to protect the low-side power switch 242. When the voltage at connection 135 is high, the current from breakdown extension circuit 263 flows to the breakdown element circuit 264 and establishes a bias voltage at Vₗₛ 106. As such, the low-side power switch 244 withstands the bias voltage at Vₗₛ 106 while the remaining voltage stress at the connection 135 is withstood by the low-side power switch 242. For example, if the voltage at the connection 135 is 150V, the voltage at Vₗₛ 106 may be biased by the breakdown extension circuit 263 and the breakdown element circuit 264 to, for example, 70V. As such, the low-side power switch 244 withstands approximately 70V while the low-side power switch 242 withstands 150V minus 70V, a difference of approximately 80V. As a result, the gate voltage, e.g., Vₗₛ 106, for the low-side power switch 242 is asserted high to engage the low-side power switch 242. Engaging the low-side power switch 242 substantially distributes the voltage across the low-side power switches 242 and 244, thereby protecting the low-side power switches 242-244 and the components within the first portion of converter circuit 250 that are connected to the low-side power switches 242-244. In other words, a high voltage is sensed by the low side circuit 280 and as a result the voltage is distributed among the low-side power switches 242-244 to reduce their respective voltage stress.

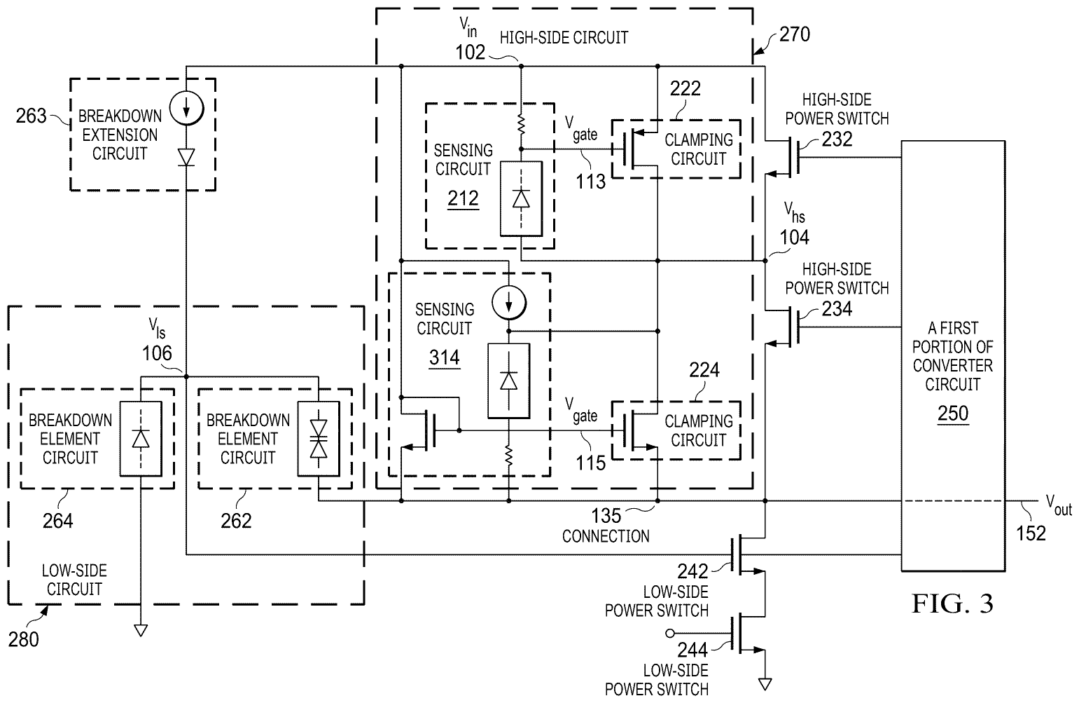

FIG. 3 is yet another schematic diagram of a system with a circuitry to extend cascode switches of a first portion of converter circuit to operate beyond the process breakdown voltage, in an example. FIG. 3 is substantially similar to that of FIG. 2 except that the sensing circuit 214 of FIG. 2 is replaced with the sensing circuit 314. The sensing circuit 314 operates substantially similar to that of sensing circuit 214 except that the additional switch and the capacitor are used. The capacitor within the sensing circuit 314 senses rapid decline in the voltage at connection 135 and in response thereto the current passes through the capacitor and flows into the resistor that triggers the clamping circuit 224 to start clamping. As a result, the switch within the clamping circuit 224 in FIG. 3 is turned on stronger in comparison to that in FIG. 2 due to the additional current provided by the capacitor. Moreover, the capacitor in the sensing circuit 314 reacts faster to a drop in voltage in comparison to diode, thereby triggering the clamping circuit 224 earlier in comparison to that of FIG. 2.

As illustrated in FIGS. 1-3 stacking the high-side power switches and low-side power switches and using the high side and low side circuitries extend the maximum operating voltage of the switching first portion of converter circuit. The oxide breakdown voltage of the configurations, as described above, no longer limits the input voltage, Vᵢₙ 102 and the maximum operating voltage that may be increased substantially, e.g., 150V. For example, in an on state (when the first portion of converter circuit is switching), the triggering and clamping process on the high side and the breakdown in the low side dynamically turn the stacked switches (e.g., high-side power switches and low-side power switches) on/off, fixing the voltage across gate-source to approximately 5V independent of Vᵢₙ 102 and reducing the drain-source and gate-drain voltage across each switch. Thus, the oxide breakdown voltage is no longer limiting the maximum Vᵢₙ 102. Moreover, the configurations are compatible with both the high side and low side cascaded FETs and are more robust by sensing and triggering the clamping process during fast and varying switching transients across fabrication variations, therefore protecting against voltage stress by distributing the voltage across a number of components and switches, as described above. Additionally, the configurations described above eliminate use of additional auxiliary rails, thereby reducing cost, complexity, pinout, silicon area, etc.

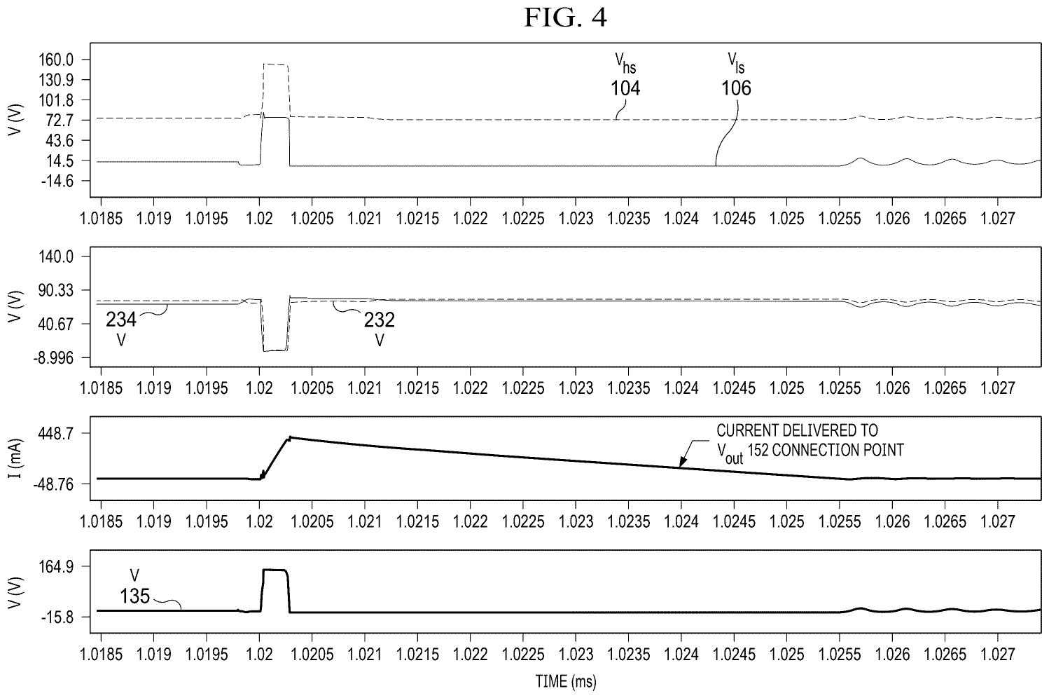

FIG. 4 is a performance of the system with a circuitry to extend cascode switches of a converter circuit to operate beyond the process breakdown voltage, in an example. As illustrated, the maximum operating voltage of switching converter circuits has increased to twice the device breakdown (first plot) while maintaining each individual device within the breakdown limits (second plot illustrating voltage difference between the drain and source of switches 232 and 234). In other words, existing node process at a lower voltage rating may be used to operate at higher power applications despite the lower voltage rating, thereby reducing cost such as pin out, additional auxiliary rails, silicon area, and build of material. The system 100 generates dynamic gate voltages for stacked power switches, e.g., FETs, to generate DC gate voltages unlike the conventional systems, thereby no longer limited by oxide breakdown (low voltage rating) and as such capable of supporting voltages beyond the breakdown operation (e.g., high power applications). The current being delivered to the fixed voltage Vₒᵤₜ 152 is illustrated as shown in plot three. Moreover, voltage at connection 135 of the converter circuit is also illustrated (plot four). As described above, the system 100, for example, senses and clamps the voltage associated with the switches during fast switching transients, thereby making the system robust across fabrication variations and preventing device breakdown (lower voltage rating) and damage across a wide range of operating conditions (high power applications). Additionally, the system 100 of FIG. 1 achieves a high conversion ratio (e.g., 150V/6V that is approximately 25:1) as opposed to a 2:1 conversion ratio, of the conventional system, by decoupling the voltages on the high side and low side (described in greater detail below).

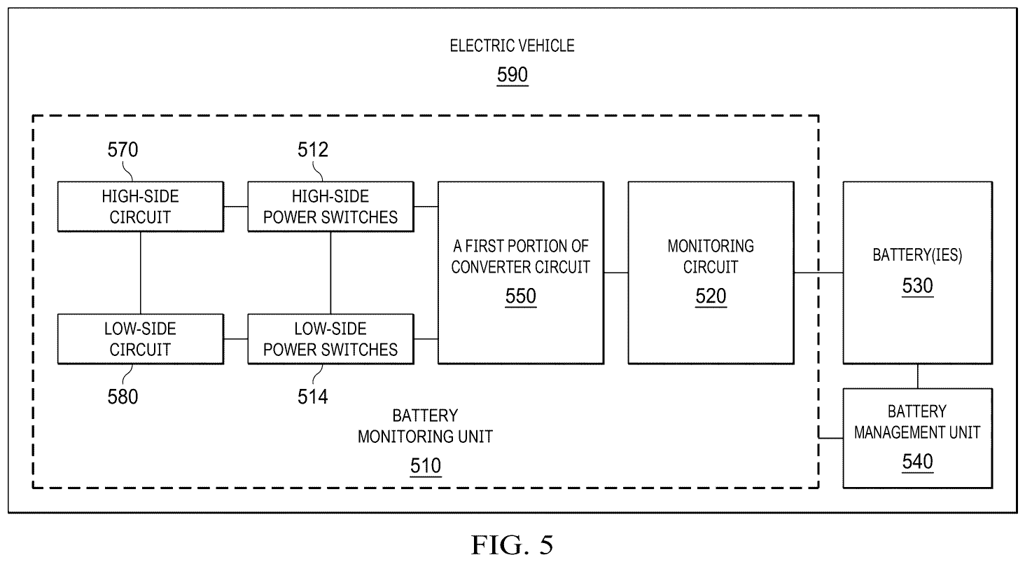

FIG. 5 is a schematic diagram of an EV including a system with a circuitry to extend cascode switches of a converter circuit to operate beyond the process breakdown voltage, in an example. An EV 590 may include batteries 530 (e.g., battery pack that generates high voltages such as 150V) as its source of energy. The battery management unit 540 manages the operation of the batteries 530. A battery monitoring unit 510 may be coupled to the battery management unit 540 and further to the batteries 530. The battery monitoring unit 510 include a monitoring circuit 520 to provide various information associated with the battery or battery pack such as cell voltage, temperature for the state of charge (SOC) or state of health (SOH), detection of battery faults, etc. The battery monitoring circuit 510 uses the source, e.g., batteries 530, to generate its internal low voltage rails. As described above, the batteries 530 may generate a high voltage such as 150V. As such, the battery monitoring circuit 510 may use a first portion of converter circuit 550 (operates similar to first portion of converter circuit 150 and/or 250) to step down the voltage to generate its internal low voltage rails. The battery monitoring unit 510 may also include a high side circuit (operates similar to the high side circuits 170 and/or 270) and a low side circuit 580 (operates similar to the high side circuits 180 and/or 280) to protect the high-side power switches 512 (similar to the high-side power switches 132-134 and/or 232-234) and low-side power switches 514 (similar to the low-side power switches 142-144 and/or 242-244) and components within the first portion of converter circuit 550.

According to some examples, a circuity is used to protect the high side and the low side switches of a converter circuit, e.g., buck converter, used in monitoring circuit from breakdown voltage while enabling the converter circuit to deliver high as well as low voltage.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on. ” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Modifications are possible in the described embodiments, and other embodiments are possible, within the scope of the claims.

What is claimed is:

1. An apparatus comprising:
a first sensing circuit;
a first clamping circuit;
a first high-side power switch;
wherein the first sensing circuit is configured to detect a voltage change across the first high-side power switch exceeding a first threshold in response to a converter circuit switching, wherein the first sensing circuit is further configured to trigger the first clamping circuit to clamp a voltage across the first high-side power switch in response to detecting that the voltage change across the first high-side power switch exceeds the first threshold,
a second sensing circuit;
a second clamping circuit; and
a second high-side power switch;
wherein the second sensing circuit is configured to detect a voltage change across the second high-side power switch exceeding a second threshold, wherein the second sensing circuit is further configured to trigger the second clamping circuit to clamp a voltage across the second high-side power switch in response to detecting that the voltage change across the second high-side power switch exceeds the second threshold.

2. The apparatus of claim 1 further comprising:
a first low-side power switch;
a second low-side power switch; and
a first breakdown element circuit,
wherein the first breakdown element circuit is configured to breakdown in response to the converter circuit switching to output a high voltage, and wherein the first breakdown element circuit is configured to engage the first low-side power switch in response to the first breakdown element circuit breaking down and wherein a voltage across the first low-side power switch is substantially a same as a voltage across the second low-side power switch after the first low-side power switch is engaged by the first breakdown element circuit.

3. The apparatus of claim 2, wherein the first breakdown element circuit conducts at approximately a breakdown voltage of the second low-side power switch.

4. The apparatus of claim 2, wherein the first high-side power switch is connected to the second high-side power switch, and wherein the second high-side power switch is connected to the first low-side power switch, and wherein the first low-side power switch is connected to the second low-side power switch.

5. The apparatus of claim 2, wherein the first high-side power switch, the second high-side power switch, the first low-side power switch, and the second low-side power switch are stacked devices.

6. The apparatus of claim 1, wherein the first clamping circuit includes a switch and wherein the second clamping circuit includes another switch.

7. The apparatus of claim 1, wherein the first sensing circuit comprises a breakdown element coupled to a resistor, wherein the breakdown element conducts in response to the voltage across the first high-side power switch exceeding the first threshold and wherein the breakdown element conducting causes the resistor to apply a voltage to the first clamping circuit that triggers clamping the voltage across the first high-side power switch.

8. The apparatus of claim 1, wherein the second sensing circuit comprises a breakdown element coupled to a resistor, wherein the breakdown element conducts in response to the voltage across the second high-side power switch exceeding the second threshold and wherein the breakdown element conducting causes the resistor to apply a voltage to the second clamping circuit that triggers clamping the voltage across the second high-side power switch.

9. The apparatus of claim 8, wherein the second sensing circuit further comprises a sensing capacitor configured to detect that the converter circuit is switching to output the low voltage, and wherein the sensing capacitor is configured to cause electrical charges to flow through the resistor to apply the voltage to the second clamping circuit.

10. The apparatus of claim 1, wherein the voltage across the first high-side power switch and the second high-side power switch is substantially the same in response to the first and the second clamping circuits clamping their respective voltages across the first and the second high-side power switches.

11. The apparatus of claim 1, wherein the first threshold is substantially a same as the second threshold.

12. The apparatus of claim 1, wherein the converter circuit is a buck converter or a stepdown converter.

13. A system comprising:
a first circuit;
a plurality of first switches coupled to the first circuit;
a second circuit;
a plurality of second switches coupled to the second circuit; and
a converter circuit coupled to the plurality of first switches and further coupled to the plurality of second switches,
wherein the first circuit is configured to detect whether a voltage change across a one switch of the plurality of first switches exceeds a threshold,
wherein the first circuit is configured to clamp a voltage across the one switch in response to detecting that the voltage change across the one switch of the plurality of first switches exceeds the threshold,
wherein the second circuit is configured to conduct in response to the converter circuit switching from a first voltage value to a second voltage value, wherein the second circuit is configured to engage another switch of the plurality of second switches in response to the converter circuit switching from the first voltage value to the second voltage value and wherein the engaging the another switch of the plurality of second switches distributes a voltage approximately uniformly across switches of the plurality of second switches.

14. The system of claim 13, wherein the voltage change across the one switch of the plurality of first switches exceeds the threshold in response to the converter circuit switching.

15. The system of claim 13, wherein second circuit includes a breakdown element circuit that conducts at approximately a breakdown voltage of the another switch of the plurality of second switches to engage the another switch of the plurality of second switches.

16. The system of claim 13, wherein switches of the plurality of first switches are connected to one another, wherein switches of the plurality of second switches are connected to one another, and wherein the plurality of first switches is connected to the plurality of second switches.

17. The system of claim 13, wherein the first circuit includes a switch configured to clamp the voltage.

18. The system of claim 13, wherein the first circuit comprises a breakdown element coupled to a resistor, wherein the breakdown element conducts in response to the voltage across the one switch of the plurality of first switches exceeding the threshold and wherein the breakdown element conducting causes the resistor to apply a voltage to a switch to clamp the voltage across the one switch of the plurality of first switches.

19. The system of claim 13, wherein the first circuit comprises a sensing capacitor configured to detect that the converter circuit is switching to output a low voltage value, and wherein the sensing capacitor is configured to cause electrical charges to flow through a resistor to apply a voltage to a switch to initiate clamping the voltage across the one switch of the plurality of first switches.

20. The system of claim 13, wherein a voltage across each one switch of the plurality of first switches is substantially the same in response to the clamping.

21. The system of claim 13, wherein the converter circuit is a buck converter or a stepdown converter.
